(19) United States
(12) Patent Application Publication
(10) Pub. No.: US 2016/0234586 A1
(43) Pub. Date: Aug. 11, 2016

(54) ELECTROACOUSTIC TRANSDUCER

(71) Applicants: Yu SUGATA, Lisle, IL (US); Makoto SHINYAMA, Lisle, IL (US); Yoshikatsu FUJIMOTO, Lisle, IL (US); MOLEX INCORPORATED, Lisle, IL (US)

(72) Inventors: Yu SUGATA, Yamato, Kanagawa (JP); Mokoto SHINYAMA, Yamato (JP); Yoshikatsu FUJIMOTO, Yamato, Kanagawa (JP)

(73) Assignee: Molex, LLC, Lisle, IL (US)

(21) Appl. No.: 15/021,911

(22) PCT Filed: Oct. 16, 2014
(86) PCT No.: PCT/US2014/060808

§ 371 Date: Mar. 14, 2016

(30) Foreign Application Priority Data
Oct. 16, 2013 (JP) 2013-215469

(51) Int. Cl. H04R 1/06; H04R 11/02

(52) U.S. Cl. CPC H04R 1/06; H04R 11/02

(57) ABSTRACT

An electroacoustic transducer for converting electric signals into acoustic waves and outputting the acoustic waves is disclosed. The transducer includes a housing having an outlet for the acoustic waves on a front surface side, a balanced armature drive unit and a diaphragm arranged inside the housing, and an external connection terminal arranged along a back surface side of the housing and connected electrically to a coil of the drive unit. The external connection terminal has an external connection portion for receiving electrical signals inputted from the outside, and a coil connecting portion connected to the coil and surrounded by a bobbin around which the coil has been wound. The coil connecting portion is connected to the coil and arranged so the external connection portion runs along the back surface of the housing.

### REFERENCE To RELATED APPLICATIONS

The Present Disclosure claims priority to prior-filed Japanese Patent Application No. 2013-215469, entitled “Electroacoustic Transducer,” filed on 16 Oct. 2013 with the Japanese Patent Office. The content of the aforementioned Patent Application is incorporated in its entirety herein.

### BACKGROUND OF THE PRESENT DISCLOSURE

The Present Disclosure relates, generally, to a balanced armature electroacoustic transducer used in medical and audio devices, and, more particularly, to an electroacoustic transducer in which an external connection terminal is connected along the back surface of the housing to facilitate connection of the external connection terminal to a coil, while also reducing the number of connection points and improving connection reliability.

Electroacoustic transducers used in medical devices such as hearing aids and in audio devices such as earphones and headsets are known to include balance armature drive units. For example, the electroacoustic transducer described in UK Patent Application No. 9005574.0 (the content of which is incorporated in its entirety herein) includes a housing having an outlet for the acoustic waves on a front surface side, a balanced armature drive unit and a diaphragm arranged inside the housing, and external connection terminals arranged along a back surface side of the housing and connected electrically to a coil of the drive unit. Electrical signals inputted from the external connection terminal are converted to acoustic waves by the drive unit and the diaphragm, and the acoustic waves are outputted via the outlet.

Because the external connection terminal in this type of electroacoustic transducer is arranged along the back surface of the housing, the direction of sound emission remains centered on the nominal diameter and does not expand in the vertical and lateral directions. This allows the medical device or audio device incorporating the electroacoustic transducer to be more compact.

However, when an external connection terminal is arranged along the back surface of the housing in an electroacoustic transducer, the terminal base plate on which the external connection terminal has been mounted is fixed to the back surface portion of the housing and the terminal base plate and the coil are connected to each other electrically via a wire. As a result, it is difficult to connect the wire to the terminal base plate, and a disconnection may occur during the connection operation. Also, because a wire has to be connected at two points on a single external connection terminal, high connection reliability is difficult to obtain.

### SUMMARY OF THE PRESENT DISCLOSURE

Therefore, it is an object of the Present Disclosure to solve this problem by providing electroacoustic transducer in which an external connection terminal is connected along the back surface of the housing to facilitate connection of the external connection terminal to a coil, while also reducing the number of connection points and improving connection

In order to achieve this object, the Present Disclosure provides an electroacoustic transducer for converting electric signals inputted from the outside into acoustic waves and outputting the acoustic waves. The electroacoustic transducer includes a housing having an outlet for the acoustic waves on a front surface side, a balanced armature drive unit and a diaphragm arranged inside the housing, and external connection terminals arranged along a back surface side of the housing and connected electrically to a coil of the drive unit. In this electroacoustic transducer, the external connection terminal has an external connection portion for receiving electric signals inputted from the outside, and a coil connecting portion connected to the coil and surrounded by a bobbin around which the coil has been wound. In addition, the coil connecting portion is connected to the coil and arranged so the external connection portion runs along the back surface of the housing.

The Present Disclosure is able to provide an electroacoustic transducer in which an external connection terminal is connected along the back surface of the housing to facilitate connection of the external connection terminal to a coil, while also reducing the number of connection points and improving connection reliability.

### BRIEF DESCRIPTION OF THE FIGURES

The organization and manner of the structure and operation of the Present Disclosure, together with further objects and advantages thereof may best be understood by reference to the following Detailed Description, taken in connection with the accompanying Figures, wherein like reference numerals identify like elements, and in which:

FIG. 1 is a cross-sectional view of an earphone incorporating an electroacoustic transducer according to an embodiment of the Present Disclosure;

FIG. 2 is a cross-sectional view of the electroacoustic transducer of FIG. 1;

FIG. 3 is an exploded perspective view of the electroacoustic transducer of FIG. 2;

FIG. 4 is a perspective view of the external connection terminal and magnet strap prior to insertion molding of the electroacoustic transducer of FIG. 2;

FIG. 5 is a perspective view of the external connection terminal, pad, bobbin and magnet strap after insertion molding of the electroacoustic transducer of Fig, 2; and

FIG. 6 is a perspective view of the completed drive unit in the electroacoustic transducer of FIG. 2.

### DETAILED DESCRIPTION

While the Present Disclosure may be susceptible to embodiment in different forms, there is shown in the Figures, and will be described herein in detail, specific embodiments, with the understanding that the Present Disclosure is to be considered an exemplification of the principles of the Present Disclosure, and is not intended to limit the Present Disclosure to that as illustrated.

As such, references to a feature or aspect are intended to describe a feature or aspect of an example of the Present Disclosure, not to imply that every embodiment thereof must have the described feature or aspect. Furthermore, it should be noted that the description illustrates a number of features. While certain features have been combined together to illustrate potential system designs, those features may also be used in other combinations not expressly disclosed. Thus, the depicted combinations are not intended to be limiting, unless otherwise noted.

In the embodiments illustrated in the Figures, representations of directions such as up, down, left, right, front and rear, forward and rearward, used for explaining the structure and movement of the various elements of the Present Disclosure, are not absolute, but relative. These representations are appropriate when the elements are in the position shown in the Figures. If the description of the position of the elements changes, however, these representations are to be changed accordingly.

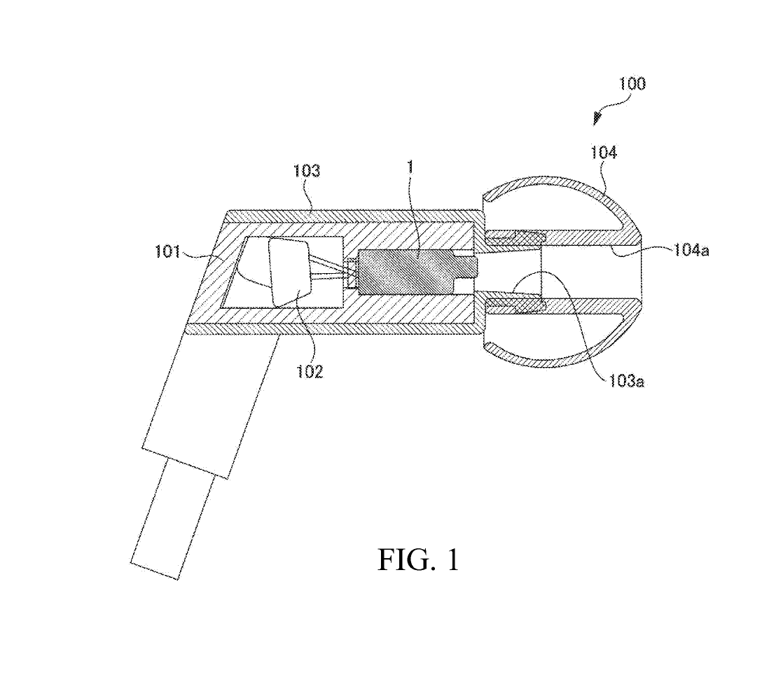

FIG. 1 is a cross-sectional view of an earphone incorporating an electroacoustic transducer according to an embodiment of the Present Disclosure. Because the electroacoustic transducer converts electric signals into acoustic waves, it can be incorporated into an earphone 100, as shown in FIG. 1, or into a headset or hearing aid. The earphone 100 has a bush 101 holding the electroacoustic transducer 1, a cable 102 connected electrically to the electroacoustic transducer 1, a body 103 covering the bush 101, and an ear pad 104 attached to the leading end of the body 103. The ear pad 104 is inserted into the ear.

The cable 102 is connected to audio equipment (not shown) such as a music player, television or radio via a connector (not shown) on the other end, and inputs electric signals outputted from the audio equipment to the electroacoustic transducer 1. The electroacoustic transducer 1 converts the inputted electric signals into acoustic waves, and outputs the converted acoustic waves from the front end. The acoustic waves outputted from the electroacoustic transducer 1 propagate via the acoustic guide holes 103a, 104a in the body 103 and the ear pad 104 towards the user's ear.

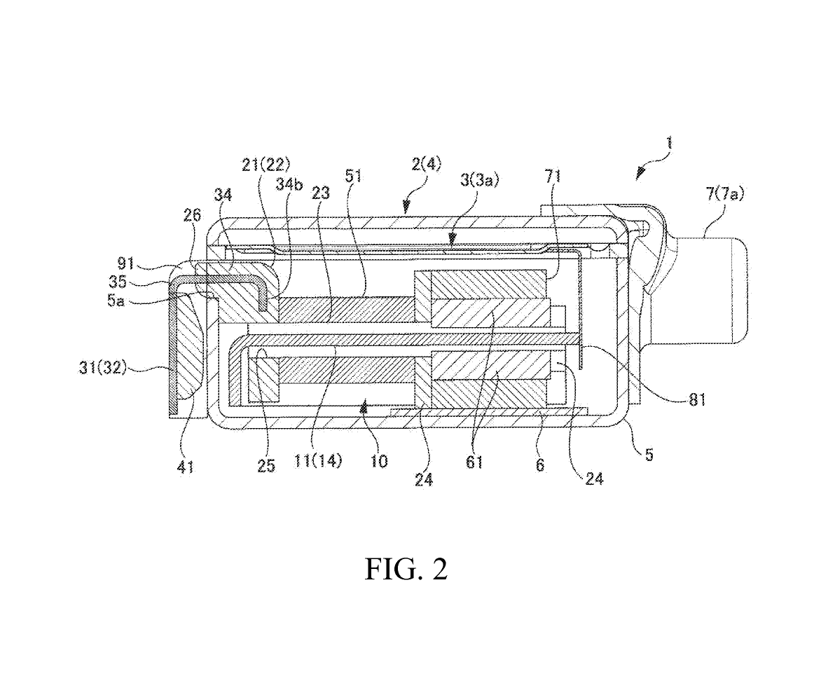

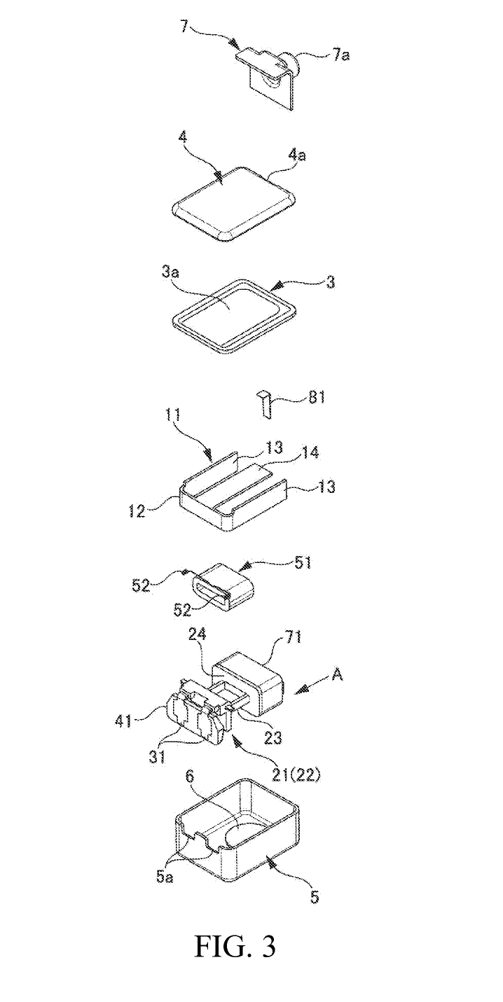

Referring to FIGS. 2-3, the electroacoustic transducer 1 has a housing 2, a diaphragm unit 3, and a drive unit 10. The housing 2 is composed of a top housing 4 and a bottom housing 5, The top housing 4 and the bottom housing 5 are connected to each other via a fixing means such as laser welding or an adhesive with the diaphragm unit 3 interposed between them. The bottom housing 5 has a box-like shape and an open upper surface. The upper surface opening in the bottom housing 5 is covered by the diaphragm 3, and the drive unit 10 is arranged in the space covered by the bottom housing 5 and the diaphragm unit 3. The drive unit 10 is fixed to the bottom portion of the bottom housing 5 via a spacer 6 in order to provide a magnetic shield. More specifically, after fixing the spacer 6 to the bottom portion of the bottom housing 5 via a fixing means such as laser welding or an adhesive, the drive unit 10 is fixed to the spacer 6 via a fixing means such as laser welding or an adhesive.

The upper surface of the diaphragm unit 3 is covered by the top housing 4. A cutout portion is formed in a portion of the top housing 4 to serve as an outlet 4a for the acoustic waves, and the space covered by the diaphragm unit 3 and the top housing 4 communicates with the space outside of the housing 2 via the cutout portion. In the present specification, the outlet 4a is formed on the front surface side of the housing 2.

The drive unit 10 includes an armature 11, a bobbin 21, a pair of external connection terminals 31, a pad 41, a coil 51, a pair of magnets 61, a magnet strap 71 and a drive pin 81. The armature 11 is a metal plate that has been bent into a substantially E-shaped form when viewed from above, and has a base plate portion 12, a pair of side plate portions 13 extending from both ends of the base plate portion 12, and a vibrating portion 14 extending from the central portion of the base plate portion 12 between the side plate portions 13. The pair of side plate portions 13 are fixed to the outside surface portion of the magnet strap 71 using a fixing means such as laser welding. The bobbin 21 has a coil winding portion 23 around which a coil 51 has been wound, and a magnet positioning portion 24 for positioning the pair of magnets 61, The base portion 22, the coil winding portion 23, and the magnet positioning portion 24 are integrally molded using a resin material.

The base portion 22 has a surface which is substantially parallel to the base portion 12 of the armature 11. A through-hole 25 is formed in the center of the base portion 22 through which the vibrating portion 14 of the armature 11 passes. A portion of the pair of external connection terminals 31 is embedded in the upper portion of the base portion 22. Each external connection terminal 31 has an external connection portion 32 for receiving electric signals inputted from the outside, a coil connecting portion 33 connected to the coil 51, an embedded portion 34 embedded in the bobbin 21, and a linking portion 35 linking the coil connecting portion 33 (embedded portion 34) to the external connection portion 32. The terminal has a reverse L-shape when viewed from the side after completion, and is integrated with the base portion 22 when the bobbin 21 is molded.

A pair of protruding portions 26 which protrude towards the back surface are integrally formed in the base portion 22. The pair of protruding portions 26 are formed in positions corresponding to the pair of cutout portions 5a. formed in the back surface portion of the bottom housing 5. When the drive unit 10 is incorporated into the bottom housing 5, the protruding portions 26 are fitted into the cutout portions 5a of the bottom housing 5, and position the drive unit 10 with respect to the bottom housing 5.

The linking portion 35 of the external connection terminal 31 protrudes from the leading end surface of the protruding portion 26, and is bent downward to link up with the external connection portion 32. In this way, the external connection portion 32 of the external connection terminal 31 is arranged along the back surface of the housing 2 with the drive unit 10 fixed to the bottom housing 5.

The coil winding portion 23 has a pair of arm portions 23a, 23b extending parallel to each other at a predetermined interval so as to connect the space between the base portion 22 and the magnet positioning portion 24. The coil 51 is formed by winding a coil wire 52 around the arm portions 23a, 23b. The end portion of the coil wire 52 is tied to the coil connecting portion 33 of each external connection terminal 31, and fixed to the coil connecting portion 33 using welding or soldering.

The magnet positioning portion 24 is formed so as to extend from the coil winding portion 23 to the front surface side of the housing 2. Space remains on the coil winding portion 23 side for inserting the vibrating portion 14 of the armature 11, and this covers the magnet strap 71. The pair of magnets 61 are positioned relative to the bobbin 21 so that the magnets 61 are arranged vertically to leave space for inserting the vibrating portion 14 of the armature 11. Each magnet 61 is pushed into the magnet strap 71 from the front, and is fixed to the magnet strap 71 to the outside of the magnet positioning portion 24 using a fixing means such as welding.

The magnet strap 71 is itself magnetic, and is integrated with the magnet positioning unit 24 (bobbin 21) when the bobbin 21 is integrally molded by arranging the strap to the outside of the section constituting the magnet positioning portion 24. The magnet strap 71 may be fixed to the bobbin 21 in a separate step after the bobbin 21 has been completed.

The pad 41 is a resin member which holds the external connection portion 32 of each external connection terminal 31, and which runs along the back surface of the housing 2 with the external connection portions 32 of the external connection terminals 31. When the bobbin 21 is molded, the pad 41 in the present embodiment is integrally molded with the pair of external connection terminals 31 separately using a resin. However, the bobbin 21 may also be molded at a different time.

After the drive unit 10 has been incorporated into the housing 2, the pad 41 is bonded. to the back surface of the housing 2 using an adhesive 91. At this time, the linking portion 35 of the external connection terminals 31 exposed inside the housing is covered with adhesive 91, and the space between the protruding portions 26 of the bobbin 21 and the housing 2 is also filled with adhesive 91.

After the vibrating portion 14 of the armature 11 has been inserted between the coil 51 and the pair of magnets 61, and the side plate portions 13 of the armature 11 have been fixed to the outside surface portion of the magnet strap 71, the drive pin 81 is fixed to the leading end portion of the vibrating portion 14 using a fixing means such as laser welding. The drive pin 81 fixed to the vibrating portion 14 extends upward, and the upper end portion is fixed to the diaphragm 3a in the diaphragm unit 3 using a fixing means such as laser welding when the drive unit 10 is incorporated into the housing 2.

In operation, a magnetic circuit is formed in the electroacoustic transducer 1 by the pair of magnets 61, and a direct current magnetic field is generated between the magnets 61. When electric signals are applied to the coil 51 via the pair of external connection terminals 31, an alternating current is generated and the alternating current magnetic flux flows through a magnetic circuit composed of the vibrating portion 14 of the armature 11, the magnets 61, the magnetic strap 71, and the side plate portions 13 and base plate portion 12 of the armature 11. This generates an alternating current magnetic field between the magnets 61 and the vibrating portion 114 of the armature 11. Superimposing an alternating current magnetic field over a direct current magnetic field causes the vibrating portion 14 of the armature 11 to vibrate. The vibration of the vibrating portion 14 is transmitted to the diaphragm 3a in the diaphragm unit 3 via the drive pin 81, and the diaphragm 3a vibrates. When the diaphragm 3a vibrates, the pressure inside the space covered by the diaphragm unit 3 and the top housing 4 changes, and the change in pressure generates acoustic waves which are outputted from the housing 2 via the outlet 4a. The electroacoustic transducer 1 in the present embodiment includes a spout 7 with a cylindrical acoustic guide 7a, and this spout 7 is fixed using a fixing means such as laser welding or an adhesive to the upper portion of the front surface of the housing 2 in which the outlet 4a is formed in order to improve the directionality of the acoustic waves outputted from the outlet 4a.

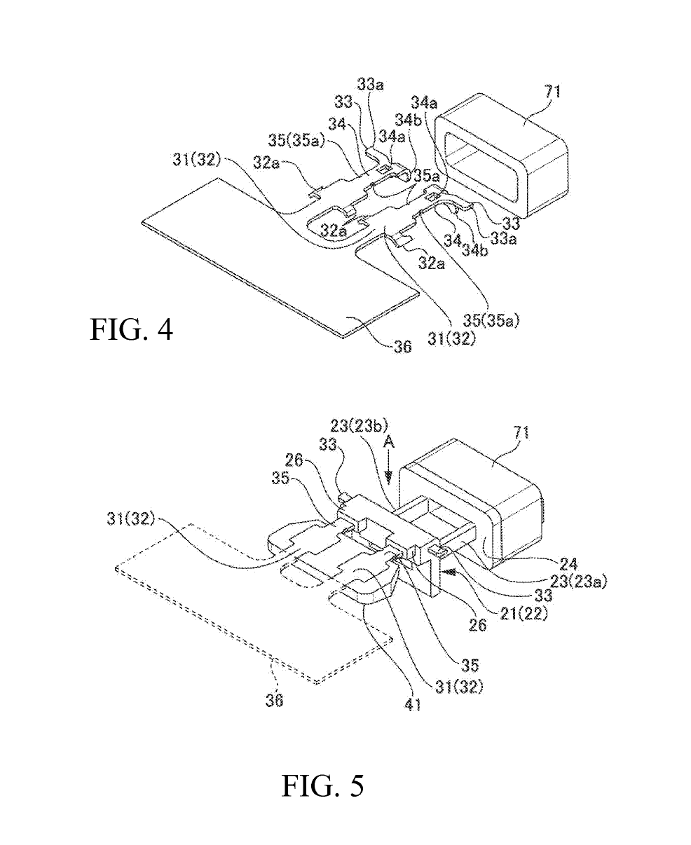

Referring to FIGS. 4-6, which illustrate the manufacture of the drive unit 10, when the drive unit 10 is manufactured, insertion molding is used in which the pair of external connection terminals 31 and the magnet strap 71 are integrally molded in the same resin used to mold the pad 41 and the bobbin 21. As shown in FIG. 4, the pair of external connection terminals 31 and the magnet strap 71 are arranged at predetermined positions in the mold when the bobbin 21, the pair of external connection terminals 31, the pad 41, and the magnet strip 71 are integrally molded in the insertion molding process.

In this step, the pair of external connection terminals 31 are integrally linked via a carrier portion 36, and the linking portion 35 is a flat plate prior to the bending process. In order to improve the integration of the pad 41, a protruding portion 32a is molded three-dimensionally in the external connection portion 32 of each external connection terminal 31 to be embedded in the pad 41. In order to improve the integration of the bobbin 21, a linking hole 34a linking the front and back resin is formed in the embedded portion 34 of each external connection terminal 31, and a bent portion 34b is formed to prevent detachment of the bobbin 21. The linking hole 34a is a through-hole formed with half-die unevenness to secure the base portion 22 and the embedded portion 34, It also maintains rigidity as a support portion when the linking portion 35 is bent at the notch 35a.

As shown in FIG. 5, an assembly A is produced by the insertion molding process which consists of the integrated bobbin 21, the pair of external connection terminals 31, the pad 41, and the magnet strap 71. After insertion molding, the carrier portion 36 of the external connection terminals 31 is severed.

After the assembly A has been molded, the pair of magnets 61 are incorporated into the magnet positioning portion 24 of the bobbin 21 and fixed. A coil wire 52 is also wound around the coil winding portion 23 of the bobbin 21 to form a coil 51. The end portion of the coil wire 52 is tied to the coil connecting portions 33 of the external connection terminals 31, and is fixed to the coil connecting portions 33 using, for example, arc welding or soldering.

The external connection terminals 31 and the coil 51 are wired and connected on the assembly A composed of the integrated bobbin 21 around which the coil 51 is wound, and the external terminal connection terminals 31. This makes it easier to connect the coil 51 and the external connection terminal 31, and can prevent disconnection during the connection process. Because the wiring and connection process is performed at only one spot on each external connection terminal 31, the number of connection spots can be reduced and the reliability of the connection can be improved. In the present embodiment, each external connection terminal 31 has a projecting portion 33a at the leading end of the coil connecting portion 33 to keep the coil wire 52 tied to the coil connecting portion 33 from coming off. As shown in FIG. 4, the coil connecting portion 33 prior to the bending process is flush with an external connection terminal 31, extends to one side of the base portion 22, and is positioned above the side plate portions 13 of the armature 11. This makes the process easier when the coil connecting portion 33 is formed, and eliminates the need for additional space for arranging the coil connecting portion 33. This makes the overall device more compact.

Next, the armature 11 is incorporated into the assembly A. In this step, the vibrating portion 14 of the armature 11 is inserted into the through-hole 25 in the bobbin 21, and the side plate portions 13 of the armature 11 are fixed to the outer surface of the magnet strap 71 using a fixing means such as laser welding.

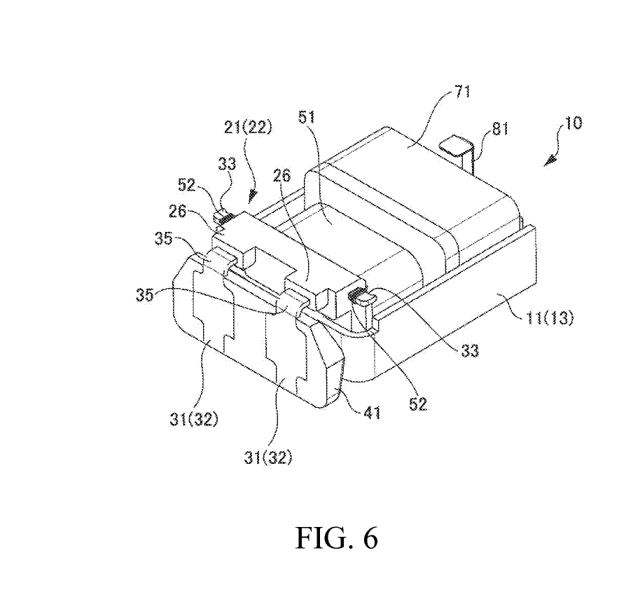

After the armature 11 has been incorporated into the assembly A, as shown in FIG. 6, the linking portion 35 of the external connection terminals 31 is bent so that the external connection portion 32 of the external connection terminals 31 and the pad 41 run along the back surface of the housing 2. A notch 35a is formed on both sides of the linking portion 35, and the linking portion 35 is bent using the notches 35a as the starting point. Finally, the drive pin 81 is fixed to the vibrating portion 14 of the armature 11 passing through the assembly A using a fixing means such as laser welding to complete the drive unit 10.

Referring to FIGS. 2-3, when the drive unit 10 is incorporated into the housing 2, the drive unit 10 is first placed inside the bottom housing 5. At this time, the protruding portions 26 formed in the bobbin 21 of the drive unit 10 are fitted into the cutout portions 5a of the bottom housing 5 to position the drive unit 10 inside the bottom housing 5. Next, the drive unit 10 is positioned relative to the bottom housing 5, and the bottom portion of the drive unit 10 is fixed to the spacer 6 secured to the bottom portion of the bottom housing 5 using a fixing means such as laser welding or an adhesive.

Next, the opening in the upper surface of the bottom housing 5 is covered by the diaphragm unit 3. At this time, the upper end of the drive pin 81 is fixed to the diaphragm 3a in the diaphragm unit 3 using a fixing means such as laser welding or an adhesive, and the bottom housing 5 and the diaphragm unit 3 are fixed using a fixing means such as laser welding or an adhesive.

Next, the diaphragm unit 3 is covered by the top housing 4. At this time, the top housing 4 is fixed to the bottom housing 5 using a fixing means such as laser welding or an adhesive with the diaphragm unit 3 interposed between the top housing 4 and the bottom housing 5 in order to form the housing 2. After the housing 2 has been formed, the spout 7 is fixed to the upper portion of the front surface of the housing 2 using a fixing means such as laser welding or an adhesive.

Next, the external connection portions 32 of the external connection terminals 31 and the pad 41 running along the back surface of the housing 2 are bonded to the back surface of the housing 2 using an adhesive 91. At this time, the linking portion 35 of the external connection terminals 31 exposed to the outside in the housing 2 are covered with the adhesive 91, and the spaces between the protruding portions 26 of the bobbin 21 and the housing 2 are filled in with the adhesive 91. When this step has been finished, the drive unit 10 has been incorporated into the housing 2, and the electroacoustic transducer 1 is complete.

In the embodiment described above, the electroacoustic transducer 1 includes a housing 2 having an outlet 4a for the acoustic waves on a front surface side, a balanced armature drive unit 10 and a diaphragm 3a arranged inside the housing 2, and external connection terminals arranged along a back surface side of the housing 2 and connected electrically to a coil 51 of the drive unit 10. The external connection terminals 31 have an external connection portion 32 for receiving electric signals inputted from the outside, and a coil connecting portion 33 connected to the coil 51, a pad 41 holding the external connection portion 32, and a bobbin 21 around which the coil 51 has been wound. These are integrally molded with the external connection terminals 31 using a resin. The coil 51 wound around the bobbin 21 is connected directly to the coil connecting portion 33, and the external connection portion 32 and the pad 41 run along the back surface of the housing 2. The external connection terminals 31 also run along the back surface of the housing 2. In this electroacoustic transducer 1, the external connection terminals 31 and coil 51 are wired and. connected on an assembly A in which the bobbin 21 around which the coil 51 is wound and the external connection terminals 31 have been integrated. As a result, the coil 51 and the external connection terminals 31 are easy to connect, and disconnections are prevented during the connection process. Because coil 51 is connected directly to the coil connecting portion 33 of the external connection terminals 31, and the wiring and connection process for the coil 51 is performed at only one spot on each external connection terminal 31, the number of connection spots can be reduced and the reliability of the connection can be improved. Because the pad 41 and the bobbin 21 are molded separately from resin and are integrally linked via the external connection terminals 31, there is a greater degree of freedom in determining the shape and arrangement of the pad 41 and the bobbin 21 compared to a situation in which the pad 41 and the bobbin 21 are integrally molded.

By bending the linking portion 35 linking the pad 41 and the bobbin 21 in the external connection terminals 31, the external connection portion 32 and the pad 41 run along the back surface of the housing 2. For example, by bending the linking portion 35 after incorporation of the armature 11, the external connection portions 32 and the pad 41 can run along the back surface of the housing 2 without obstructing the process of incorporating the armature 11. Because the linking portion 35 of the external connection terminals 31 is covered with an adhesive 91 when the pad 41 is bonded to the back surface of the housing 2, the linking portion 35 of the external connection terminals 31 is prevented from establishing a short with the housing 2 or another component, and the manufacturing process can be simplified compared to a situation in which the linking portion 35 is coated in another step.

A preferred embodiment of the Present Disclosure was described in detail above. However, the Present Disclosure is not limited to the embodiment described above. Various modifications and improvements are possible within the spirit of Present Disclosure described in the claims. For example, when assembly A is formed, a pad 41 does not have to be formed for the external connection terminals 31, and the external connection portions 32 can run along the back surface alone. In this embodiment, shorts can be prevented between the back surface of the housing 2 and the external connection portions 32 running along the back surface by providing a thin, insulating resin sheet between the back surface of the housing 2 and the external connection portions 32. This also allows for a more compact device. Further, the electroacoustic transducer 1 in the present embodiment has a pair of external connection terminals, but the number of external connection terminals is not limited to a pair. For example, the Present Disclosure can be advantageously embodied in an electroacoustic transducer with three terminals including a GND connection.

What is claimed is:

1. An electroacoustic transducer for converting electric signals inputted from the outside into acoustic waves and outputting the acoustic waves, the electroacoustic transducer comprising:
a housing having an outlet for the acoustic waves on a front surface side;
a balanced armature drive unit and a diaphragm arranged inside the housing; and
external connection terminals arranged along a back surface side of the housing and connected electrically to a coil of the drive unit;
wherein:
the external connection terminals have an external connection portion for receiving electric signals inputted from the outside, and a cod connecting portion connected to the coil and surrounded by a bobbin around which the coil has been wound; and
the coil connecting portion are connected to the coil and arranged so the external connection portion runs along the back surface of the housing.

2. The electroacoustic transducer of claim 1, wherein the external connection portion is supported by a pad made of a resin.

3. The electroacoustic transducer of claim 2, wherein the pad and the bobbin are formed simultaneously but separately using a resin, and are integrally linked via the external connection terminal.

4. The electroacoustic transducer of claim 3, wherein the external connection terminal is formed so as to have a flat surface linking the external connection portion and the coil connecting portion via a linking portion, and the linking portion is bent so the external connection portion runs along the back surface of the housing.

5. The electroacoustic transducer of claim 4, wherein the linking portion is covered with an adhesive when the external connection terminal is bonded to the back surface of the housing.

6. The electroacoustic transducer of claim 1, wherein the external connection terminal is formed so as to have a flat surface linking the external connection portion and the coil connecting portion via a linking portion, and the linking portion is bent so the external connection portion runs along the back surface of the housing.

7. The electroacoustic transducer of claim 6, wherein the linking portion is covered with an adhesive when the external connection terminal is bonded to the back surface of the housing.

8. The electroacoustic transducer of claim 2, wherein the external connection terminal is formed so as to have a flat surface linking the external connection portion and the coil connecting portion via a linking portion, and the linking portion is bent so the external connection portion runs along the back surface of the housing.

9. The electroacoustic transducer of claim 8, wherein the linking portion is covered with an adhesive when the external connection terminal is bonded to the back surface of the housing.

10. The electroacoustic transducer of claim 1, wherein the linking portion is covered with an adhesive when the external connection terminal is bonded to the back surface of the housing.

11. The electroacoustic transducer of claim 2, wherein the linking portion is covered with an adhesive when the external connection terminal is bonded to the back surface of the housing.

12. The electroacoustic transducer of claim 3, wherein the linking portion is covered with an adhesive when the external connection terminal is bonded to the back surface of the housing.
